(19) United States
(12) Patent Application Publication
(10) Pub. No.: US 2016/0186767 A1
(43) Pub. Date: Jun. 30, 2016

(54) METHOD FOR PRODUCING MEMBER FOR FLUID MACHINES, AND MEMBER FOR FLUID MACHINES

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventors: Toyoaki YASUI, Tokyo (JP); Kyoichi IKENO, Hiroshima-shi (JP)

(73) Assignees: MITSUBISHI HEAVY INDUSTRIES, LTD., Tokyo (JP); MITSUBISHI HEAVY INDUSTRIES COMPRESSOR CORP., Tokyo (JP)

(21) Appl. No.: 14/907,731

(22) PCT Filed: Jul. 23, 2014
(86) PCT No.: PCT/JP2014/069446

§ 371 Date: Jan. 26, 2016

(30) Foreign Application Priority Data
Sep. 30, 2013 (JP) 2013-204623

(51) Int. Cl. F04D 29/02; F04D 29/24; F04D 29/30; F01D 5/28

(52) U.S. Cl. CPC F04D 29/023; F01D 5/288; F04D 29/026; F04D 29/24; F04D 29/30; F05D 2220/31; F05D 2230/90; F05D 2300/228; F05D 2300/2102

(57) ABSTRACT

A method for producing a member for fluid machines, which includes: a coating step of applying a glass-based material to the surface of a base; a smoothing step of removing some of the glass-based material while heating and melting the glass-based material after the coating step; and a solidification step of solidifying the heated and melted glass-based material after the smoothing step.

### TECHNICAL FIELD

The present invention relates to a method for producing a member for fluid machines in which a fluid comes into contact with a surface of the member, and a member for fluid machines.

Priority is claimed on Japanese Patent Application No. 2013-204623, filed Sep. 30, 2013, the content of which is incorporated herein by reference.

### BACKGROUND ART

For example, a working fluid such as gas or a fluid comes into contact with a member for fluid machines such a blade of a steam turbine or an impeller in a centrifugal compressor (centrifugal pump). However, since contact resistance increases or fine particles in the working fluid are attached to the member, there is a problem that operating efficiency of the device decreases.

In order to solve the above-described problem, for example, surface roughness of the member for fluid machines is decreased by performing polishing on the surface of the base of the member for fluid machines, or surface smoothing coating is applied to the member so as to prevent attachment of fine particles to the member. PTL 1 discloses that a ceramic layer or a carbon layer in which the maximum height Ry of the surface roughness does not exceed 1.0 μm is provided on a surface of a base as a surface smoothing coating.

### CITATION LIST

### Patent Literature

[PTL 1] Japanese Unexamined Patent Application Publication No. 2007-162613

### SUMMARY OF INVENTION

### Technical Problem

However, when polishing is performed so as to decrease surface roughness of a member, it is not possible to avoid an increase in cost, and a period required for production of the member is extended. In addition, when the surface smoothing coating is formed as described in PTL 1, in a step before the coating is formed, it is necessary to perform buff grinding on the base surface and perform finishing so as to set the maximum height Ry of the surface roughness to 0.1 μm to 1.0 μm. Accordingly, similarly, there are problems that the cost increases or the period of the production is extended.

The present invention provides a method for producing a member for fluid machines and a member for fluid machines capable of improving operating efficiency of fluid machines while decreasing costs.

### Solution to Problem

According to a first aspect of the present invention, there is provided a method for producing a member of fluid machines, including: a coating step of applying a glass-based material to a surface of a base; a smoothing step of removing some of the glass-based material while heating and melting the glass-based material after the coating step; and a solidification step of solidifying the heated and melted glass-based material after the smoothing step.

In the method for producing a member for fluid machines, after the glass-based material is applied to the base in the coating step, some of the glass-based material is removed in the smoothing step. Accordingly, after the glass-based material is applied, the base surface is smoothened. Therefore, even when surface roughness of the surface of the base increases, it is possible to achieve smoothing with respect to the surface of the member for fluid machines while a step of decreasing the surface roughness by polishing the surface of the base before the coating step is performed or the like is not required. As a result, it is possible to decrease contact resistance between a fluid and the member for fluid machines, and it is possible to reduce an amount of matter attached to the member for fluid machines.

Moreover, in a method for producing a member of fluid machines according to a second aspect of the present invention, in the first aspect, the method may further include a rough processing step of performing rough processing on the surface of the base before the coating step.

By performing the rough processing step, the surface roughness of the base surface is decreased to some extent, and in a state where a maximum height Ry of the surface roughness is decreased, the coating step is performed. Since the position at which the base surface has the maximum height Ry becomes the minimum thickness dimension of the coated glass-based material, the glass-based material is applied in the state where the surface roughness of the base surface is decreased, and it is possible to decrease the thickness dimension of the glass-based material. Accordingly, it is possible to decrease time required for the coating step and material costs of the glass-based material, and thus costs are decreased.

In addition, in a method for producing a member of fluid machines according to a third aspect of the present invention, in the first or second aspect, the method may further include a nickel plating step of performing nickel plating processing on the surface of the base before the coating step.

The nickel plating layer can be formed on the base surface by the nickel plating step, and it is possible to prevent oxidation of the base surface before the coating step is performed. Accordingly, it is possible to improve adhesion between the glass-based material applied by the coating step and the base.

In addition, in a method for producing a member of fluid machines according to a fourth aspect of the present invention, in the first or second aspect, the method may further include a nitriding step of performing nitriding processing on the surface of the base so as to harden the surface before the coating step.

According to the nitriding step, since a dense nitride layer is formed on the base surface, it is possible to improve adhesion between the glass-based material applied by the coating step and the base.

Moreover, in a method for producing a member of fluid machines according to a fifth aspect of the present invention, in any one of the first to the fourth aspects, in the smoothing step, the base may be rotated and some of the glass-based material may be removed.

By rotating the base, the melted glass-based material can be removed so as to be scattered by centrifugal force, and it is possible to easily obtain the glass-based material layer having a smooth surface.

In addition, according to a sixth aspect of the present invention, there is provided a member for fluid machines, including: a base in which a fluid flows to a surface side of the base; and a glass coating layer which is applied to the surface of the base and in which a surface positioned on a side opposite to the surface of the base formed of a glass-based material is smooth.

In the member for fluid machines, even when the surface roughness of the surface of the base which comes into contact with the glass-based material is large, the surface of the glass coating layer is smooth. Accordingly, even when the surface roughness of the surface of the base is not small, it is possible to decrease the contact resistance between a fluid and the member for fluid machines by the glass coating layer, and it is possible to decrease an amount of matter attached to the member for fluid machines.

In addition, in a method for producing a member of fluid machines according to a seventh aspect of the present invention, in the sixth aspect, the method may further include nickel plating layer which is provided between the base and the glass coating layer.

According to the nickel plating layer, it is possible to improve adhesion between the base and the glass coating layer.

Moreover, in a method for producing a member of fluid machines according to an eighth aspect of the present invention, in the sixth aspect, the method may further include a nitride layer which is provided between the base and the glass coating layer.

According to the nitride layer, it is possible to improve adhesion between the base and the glass coating layer.

### Advantageous Effects of Invention

According to the method for producing a member for fluid machines and the member for fluid machines, a glass-based material is applied to a base so as to smoothen the surface of the base, and it possible to improve operating efficiency of the fluid machine while decreasing costs of the base.

### BRIEF DESCRIPTION OF DRAWINGS

FIG. 1 is a sectional view showing a member for fluid machines produced by a production method according to a first embodiment of the present invention.

FIG. 2 is a flow chart showing a procedure of the production method according to the first embodiment of the present invention.

FIG. 3 is a sectional view showing the enlarged member for fluid machines produced by the production method according to the first embodiment of the present invention, (a) shows a state before a smoothing step is performed, and (b) shows a state after the smoothing step is performed.

FIG. 4 is a sectional view showing a member for fluid machines produced by a production method according to a second embodiment of the present invention.

FIG. 5 is a flow chart showing a procedure of the production method according to the second embodiment of the present invention.

### DESCRIPTION OF EMBODIMENTS

### First Embodiment

Hereinafter, a method for producing a member 1 for fluid machines (hereinafter, simply referred to as a member 1) according to a first embodiment of the present invention will be described.

First, the member 1 which is produced by the production method of the present embodiment will be described. The member 1 is used in a steam turbine, a compressor, a pump, or the like, and a work fluid W such as gas or liquid comes into contact with the surface of the member 1 in the devices.

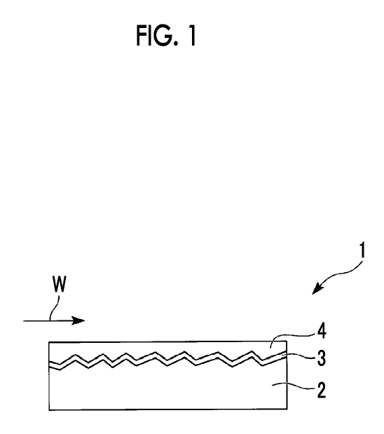

As shown in FIG. 1, the member 1 includes a base 2 which is formed of a metal material such as a steel material (for example, stainless steel or carbon steel), a nickel plating layer 3 which is laminated on the base 2, and a glass coating layer 4 which is laminated on the nickel plating layer 3.

In the base 2, a maximum height Ry in surface roughness of a surface side of the base 2 to which the nickel plating layer 3 is laminated is 20 μm to 50 μm.

For example, the nickel plating layer 3 is a Ni—B plating layer or a Ni—P plating layer.

The glass coating layer 4 is a layer which is formed of a glass-based material. For example, the glass-based material may be a general glass material such as a glass material which is used in enamel processing. Specifically, in the glass coating layer 4, a glass frit composed of mainly SiO₂ (silicon dioxide) and B₂O₃ (boron oxide), a reinforcement material such as Al₂O₃, an alkali material (solvent: Li₂O (lithium oxide), Na₂O (sodium oxide), K₂O (potassium oxide), MgO (magnesium oxide), CaO (calcium oxide), BaO (barium oxide), or the like) for decreasing a melting point, a color former (this is nonessential), and water are mixed.

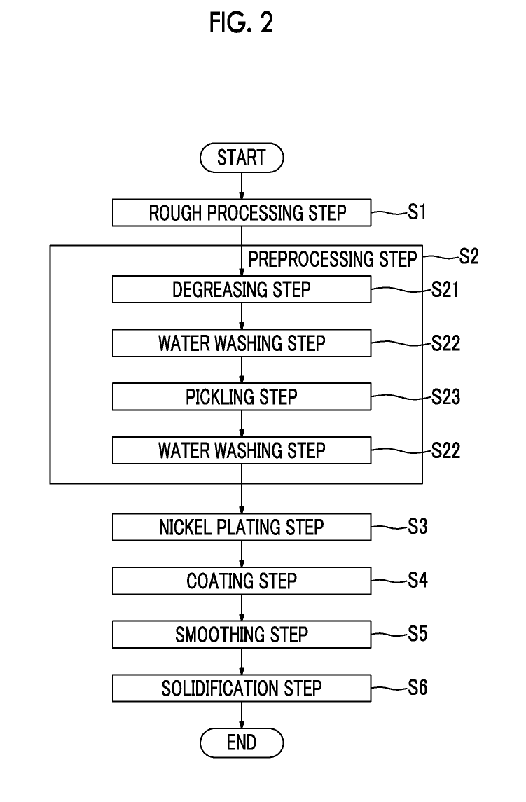

Next, with reference to FIG. 2, a procedure of the production method for producing the member 1 will be described.

The production method of the member 1 includes a rough processing step S1 which performs rough processing on the surface of the base 2, a preprocessing step S2 which has a degreasing step S21, a water washing step S22, and a pickling step S23 which performs preprocessing on the surface of the base 2 subjected to the rough processing, and a nickel plating step S3 which performs nickel plating processing on the surface of the base 2 after the preprocessing.

In addition, the production method of the member 1 includes a coating step S4 which applies a glass-based material to the surface of the base 2 after the nickel plating processing, a smoothing step S5 which removes some of the applied glass-based material, and a solidification step S6 which solidifies the applied glass-based material.

First, the rough processing step S1 is performed. That is, cutting is performed on the surface of the base 2 using an end mill or the like so as to decrease the surface roughness of the surface of the base 2. The maximum height Ry of the surface roughness on the surface of the base 2 is 20 μm to 50 μm by performing the rough processing step S1.

Next, as the preprocessing step S2 with respect to the surface of the base 2 after the rough processing, the degreasing step S21 which removes oil content is performed. Thereafter, the water washing step S22 which washes the base using water, the pickling step S23 which washes the base using an acid liquid such as hydrochloric acid or sulfuric acid so as to activate the surface of the base 2, and the water washing step S22 are performed in this order.

Thereafter, the nickel plating step S3 is performed. That is, the nickel plating layer 3 is formed on the surface of the base 2 subjected to the preprocessing as described above. In the nickel plating step S3, electroplating, electroless nickel plating, or the like is applied.

The electroless nickel plating is a method which forms a nickel plating film on the surface of a member to be plated without supplying power to the member by dipping the surface of the member to be plated in a plating liquid. According to the electroless nickel plating, it is possible to uniformly form the film on a portion having a complicated shape such as an inner surface of a channel of an impeller.

As the electroless nickel plating, Ni—B plating, Ni—P plating, or the like is exemplified. From the viewpoint of heat resistance with respect to the temperature of the glass-based material in the smoothing step S5 described below, preferably, the Ni—B plating is applied.

Next, the coating step S4 is performed. The glass-based material is applied to the surface of the base 2 on which the nickel plating layer 3 is formed. As the glass-based material, the above-described general glass material in a state of aqueous slurry or a molten glass is used. Viscosity of the aqueous slurry is 10⁻² to 1 [Pa·s], and viscosity of the molten glass is 1 to 10² [Pa·s].

In addition, as a method for applying the glass-based material, a dip coating method is used, in which after the base 2 is dipped in a container in which the aqueous slurry or the molten glass is stored, the base 2 is lifted.

Alternatively, as the method for applying the glass-based material, a dip coating method is used, in which water is removed from the aqueous slurry or the molten glass, the aqueous slurry or the molten glass in a powdery state is heated and melted in a container, the base 2 is dipped in the container in a state where the aqueous slurry or the molten glass is heated up to the same temperature as the temperature of the glass-based material in the container, and thereafter, the base 2 is lifted.

Alternatively, as the method for applying the glass-based material, a spray coating method is used in which the aqueous slurry is sprayed onto the surface of the base 2 using a sprayer.

Thereafter, the smoothing step S5 is performed. That is, some of the glass-based material is removed while the glass-based material is heated. Specifically, in a state where the temperature of the glass-based material is maintained at 750° C. to 850° C., spin coating in which the base 2 having the applied glass-based material is rotated is performed, and some of the glass-based material is removed by centrifugal force so as to form a glass-based material layer having a smooth surface. Preferably, a rotation speed when the base 2 is rotated by the spin coating is greater than a rotation speed at which uniformity of the film thickness of the glass-based material layer is maintained to some extent and smaller than a rotation speed at which the film thickness is too thin. Specifically, the spin coating is performed at a number of rotations of 60 rpm to 300 rpm, and more preferably, is performed at a number of rotations of 100 rpm to 200 rpm.

In addition, the solidification step S6 is performed. That is, the melted glass-based material is solidified so as to form the glass coating layer 4 on the surface of the base 2. Preferably, the thickness of the glass coating layer 4 is greater than a thickness at which the glass coating layer 4 is not influenced by the surface roughness of the surface of the base 2 after the rough processing step S1 is performed and is smaller than a thickness at which adhesion of the glass coating layer 4 can be secured. Specifically, preferably, thickness of the glass coating is 0.05 mm to 1 mm, and more preferably, is 0.1 mm to 0.5 mm.

Moreover, after the glass coating layer 4 is formed, preferably, the surface roughness of the surface of the glass coating layer 4 is greater than surface roughness at which there are too many required man hours in the smoothing step S5 and is smaller than surface roughness at which the contact resistance between the glass coating layer 4 and the fluid W is too great. Specifically, preferably, the surface roughness Ra is 0.01 μm to 0.1 μm, and more preferably, is 0.03 μm to 0.05 μm.

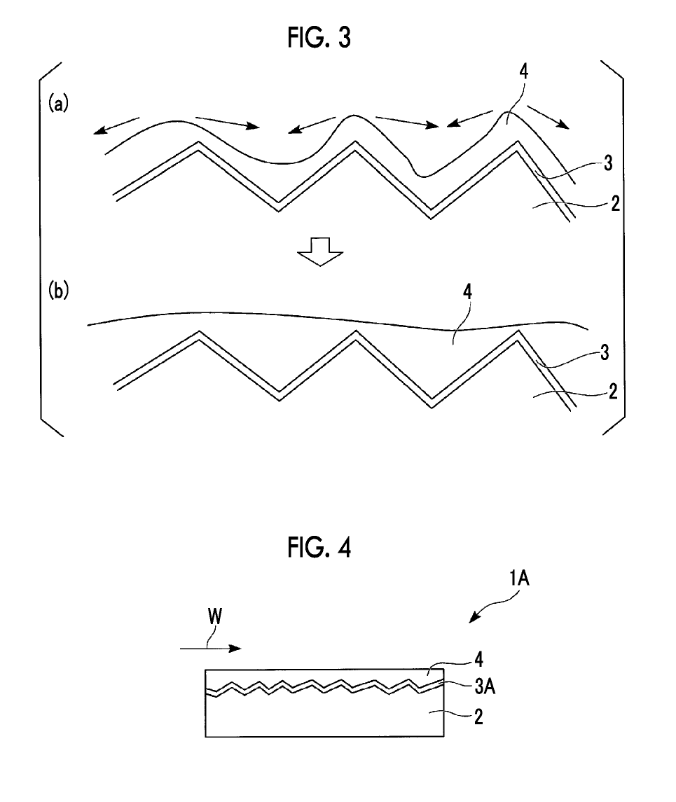

According to the method for producing the member 1, after the glass-based material is applied to the base 2 in the coating step S4, some of the glass-based material is removed in the smoothing step S5. That is, the glass-based material is blown off while flowing as shown by arrows from a state of FIG. 3(a) and is brought into a state of FIG. 3(b), and the surface of the glass coating layer 4 positioned on the side opposite to the surface of the base 2 is smoothened.

Accordingly, even when the surface roughness of the surface of the base 2 is increased, in a state where a step of decreasing the surface roughness of the surface of the base 2 by polishing or the like before the coating step S4 is performed is not necessary, it is possible to achieve smoothing of the surface of the member 1. As a result, it is possible to decrease the contact resistance between the fluid W and the member 1, and it is possible to decrease an amount of matter attached to the member 1.

Since the method for producing the member 1 includes the rough processing step S1 before the coating step S4, the surface roughness of the surface of the base 2 is decreased to some extent, and in a state where the maximum height Ry of the surface roughness is decreased, the coating step S4 is performed.

Here, the position of the maximum height Ry of the surface of the base 2 becomes the minimum thickness dimension of the applied glass-based material. Accordingly, since the glass-based material is applied in the state where the surface roughness is decreased, it is possible to decrease the thickness dimension of the glass-based material. Therefore, it is possible to decrease time required for the coating step S4 and material costs of the glass-based material, and thus the costs are decreased.

Moreover, since the method for producing the member 1 includes the nickel plating step S3 in which the nickel plating processing is performed on the surface of the base 2 after the rough processing step S1 and before the coating step S4, it is possible to form the nickel plating layer 3 on the surface of the base 2. Accordingly, before the coating step S4 is performed, it is possible to prevent oxidation of the surface of the base 2, and it is possible to improve adhesion between the glass-based material applied in the coating step S4 and the base 2.

Moreover, since some of the glass-based material is removed using the spin coating in the smoothing step S5, it is possible to scatter the melted glass-based material by centrifugal force to remove the melted glass-based material, and it is possible to easily obtain the glass coating layer 4 having a smooth surface.

According to the method for producing the member 1 of the present embodiment, since the glass-based material is applied to the base 2 so as to smoothen the surface of the base 2, polishing with respect to the surface of the base 2 before the coating step S4 can be omitted, and it is possible to improve operating efficiency of a fluid machine having the member 1 while decreasing the cost of the base 2.

Although it is not shown, the method for producing the member 1 may further include a post-processing step between the nickel plating step S3 and the coating step S4. The post-processing step includes a neutralization processing step in which after the nickel plating layer 3 is formed on the surface of the base 2, washing is performed on the surface of the nickel plating layer 3 by an alkaline aqueous solution of pH 4 to pH 4.5. In addition, the post-processing step includes a water washing step of washing the surface of the nickel plating layer 3 after the neutralization processing, and a drying step of drying the surface.

### Second Embodiment

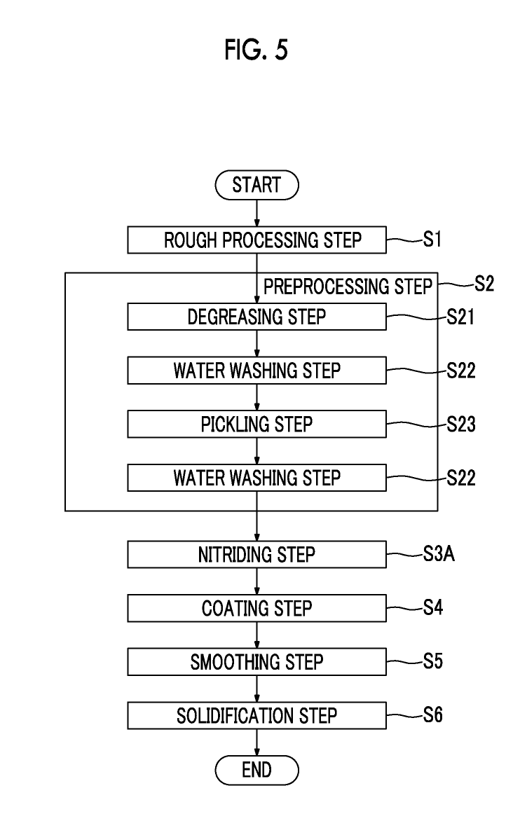

Next, with reference to FIGS. 4 and 5, a method of producing a member 1A according to a second embodiment of the present invention will be described.

The method for producing the member 1A of the present embodiment includes a nitriding step S3A instead of the nickel plating step S3 of the first embodiment.

That is, the method for producing the member 1A includes the rough processing step S1, the preprocessing step S2, the nitriding step S3A of performing nitriding processing on the surface of the base 2 after the preprocessing so as to harden the surface of the base 2, the coating step S4 after the nitriding step S3A, the smoothing step S5, and the solidification step S6.

For example, in the nitriding step S3A, nitriding processing such as gas nitriding, ion nitriding, or radical nitriding is performed on the surface of the base 2 after the preprocessing step S2, and a nitride layer 3A between the glass coating layer 4 and the surface of the base 2. The nitride layer 3A is a layer formed of dense nitride.

Here, the gas nitriding is a nitriding method in which nitrogen is diffused to a surface of a material to be processed by a reaction in which ammonia gas is dissolved into nitrogen and hydrogen and a nitride (or solid solution) layer is formed.

The ion nitriding is a nitriding method in which nitrogen and hydrogen are introduced into a furnace as reaction gas, plasma is generated on the surface of the material to be processed, ionized nitrogen is diffused to the surface of the material to be processed, and a nitride (solid solution) layer is formed.

The radical nitriding is a nitriding method in which a mixed gas of hydrogen and ammonia is introduced into the furnace as reaction gas, plasma is generated on the surface of the material to be processed, radical nitrogen is diffused to the surface of the material to be processed, and a nitride (or solid solution) layer is formed.

In the nitriding step S3A, any one of the above-described nitriding methods may be used. However, since a compound layer is not formed when the nitriding processing is performed, the radical nitriding is more suitable.

The compound layer is a layer which exists on the outermost surface of the nitride material to be processed and has a thickness of 10 μm or less and is a layer of composite nitride such as steel and chromium. Since the compound layer is brittle and is easily cracked, the surface is easily roughened, and when the compound layer is not formed, it is possible to obtain high adhesion between the glass coating layer 4 and the nitride layer 3A.

According to the method for producing the member 1A of the present embodiment, similar to the first embodiment, the polishing with respect to the surface of the base 2 before the coating step S4 can be omitted, and it is possible to improve operating efficiency of the fluid machine having the member 1A while decreasing the cost of the base 2.

In addition, in the method of the present embodiment, by performing the nitriding step S3A, a dense nitride layer 3A is formed on the surface of the base 2. Accordingly, it is possible to improve adhesion between the glass-based material applied in the coating step S4 and the base 2.

Hereinbefore, embodiments of the present invention are described in detail. However, some design modifications may be performed within a scope which does not depart from the technical idea of the present invention.

For example, the rough processing step S1 may not necessarily be performed.

In addition, in the preprocessing S2, the degreasing step S21, the pickling step S23, and the water washing step S22 may be appropriately repeated according to the conditions of the surface of the base 2, and some steps may be omitted.

Moreover, in the smoothing step S5, instead of the spin coating, a method may be used in which some of the glass-based material is blown off by pressure of air so as to remove some of the glass-based material, and a method may be used in which vibration is applied to the base 2 so as to remove some of the glass-based material.

### INDUSTRIAL APPLICABILITY

According to the method for producing a member for fluid machines and the member for fluid machines, a glass-based material is applied to a base so as to smoothen the surface of the base, and it possible to improve operating efficiency of the fluid machine while decreasing costs of the base.

### REFERENCE SIGNS LIST

1, 1A: member (for fluid machine)
2: base
3: nickel plating layer
3A: nitride layer
4: glass coating layer
S1: rough processing step
S2: preprocessing step
S21: degreasing step
S22: water washing step
S23: pickling step
S3: nickel plating step
S3A: nitriding step
S4: coating step
S5: smoothing step
S6: solidification step
W: fluid

1-8. (canceled)

9. A method for producing a member of fluid machines, comprising:
a coating step of applying a glass-based material to a surface of a base;
a smoothing step of removing some of the glass-based material while heating and melting the glass-based material after the coating step; and
a solidification step of solidifying the heated and melted glass-based material after the smoothing step,
wherein in the smoothing step, vibration is applied to the base and some of the glass-based material is removed.

10. The method for producing a member of fluid machines according to claim 9, further comprising:
a rough processing step of performing rough processing on the surface of the base before the coating step.

11. The method for producing a member of fluid machines according to claim 9, further comprising:
a nickel plating step of performing nickel plating processing on the surface of the base before the coating step.

12. The method for producing a member of fluid machines according to claim 9, further comprising:
a nitriding step of performing nitriding processing on the surface of the base so as to harden the surface before the coating step.
